(19) United States
(12) Patent Application Publication
(10) Pub. No.: US 2013/0175408 A1
(43) Pub. Date: Jul. 11, 2013

(54) HINGED CABLE MANAGEMENT SYSTEM

(71) Applicant: Brian Grelck, Hoffman Estates, IL (US)

(72) Inventor: Brian Grelck, Hoffman Estates, IL (US)

(21) Appl. No.: 13/736,307

(22) Filed: Jan. 8, 2013

Related U.S. Application Data
(60) Provisional application No. 61/584,411, filed on Jan. 9, 2012.

(51) Int. Cl. F16L 3/22

(52) U.S. Cl. CPC F16L 3/22
USPC 248/68.1

(57) ABSTRACT

A device for managing a plurality of cables in a multi-cable environment includes a stationary member having a plurality of stationary channel portions. At least one movable member is movably secured to the stationary member. The at least one movable member has a plurality of movable channel portions corresponding in number and general configuration to the plurality of stationary channel portions. A plurality of indicia-bearing areas are provided, corresponding in number, and adjacent, to the plurality of stationary channel portions. The at least one moveable member is moveable between a cable placement position in which cables can be placed in the respective stationary channel portions, and a cable retaining position in which the cables are secured in channels formed by the cooperation of the stationary channel portions and the movable channel portions.

This application claims priority under 35 U.S.C. §119(e) to U.S. Provisional Application Ser. No. 61/584,411, filed Jan. 9, 2012, which is expressly incorporated by reference herein

### BACKGROUND

The present disclosure relates generally to cables, and specifically to the management of multiple cables associated with electronic devices such as computers, servers, data systems and the like. A variety of accessories have been developed to provide cable management options to meet varying needs. Solutions range from simple cable management rings, to vertical or horizontal organizers, to troughs or ladders.

### SUMMARY

According to one aspect of the present disclosure, a device for managing a plurality of cables in a multi-cable environment includes a mount that is hinged to one or more stationary members having a plurality of channels and at least one removable member removably secured to the stationary member. The at least one removable member further includes at least one removable channel portion corresponding in general configuration to one of the plurality of stationary channel portions.

### BRIEF DESCRIPTION OF THE DRAWINGS

Embodiments of the present disclosure are illustrated by way of example, and not by way of limitation, in the figures of the accompanying drawings in which:

FIG. 1 is a perspective view of a cable management device showing a mount and a cable retention portion interconnectible by a hinge member;

FIG. 2 is a perspective view of the cable management device showing a mount and three separate cable retention portions that are pivotally connected to the mount by three separate hinges;

FIG. 3 is an exploded view of the cable management device showing the cable retention portion separated from the mount; and

FIG. 4 is an exploded view of a cable management device having three cable retention portions.

### SPECIFICATION

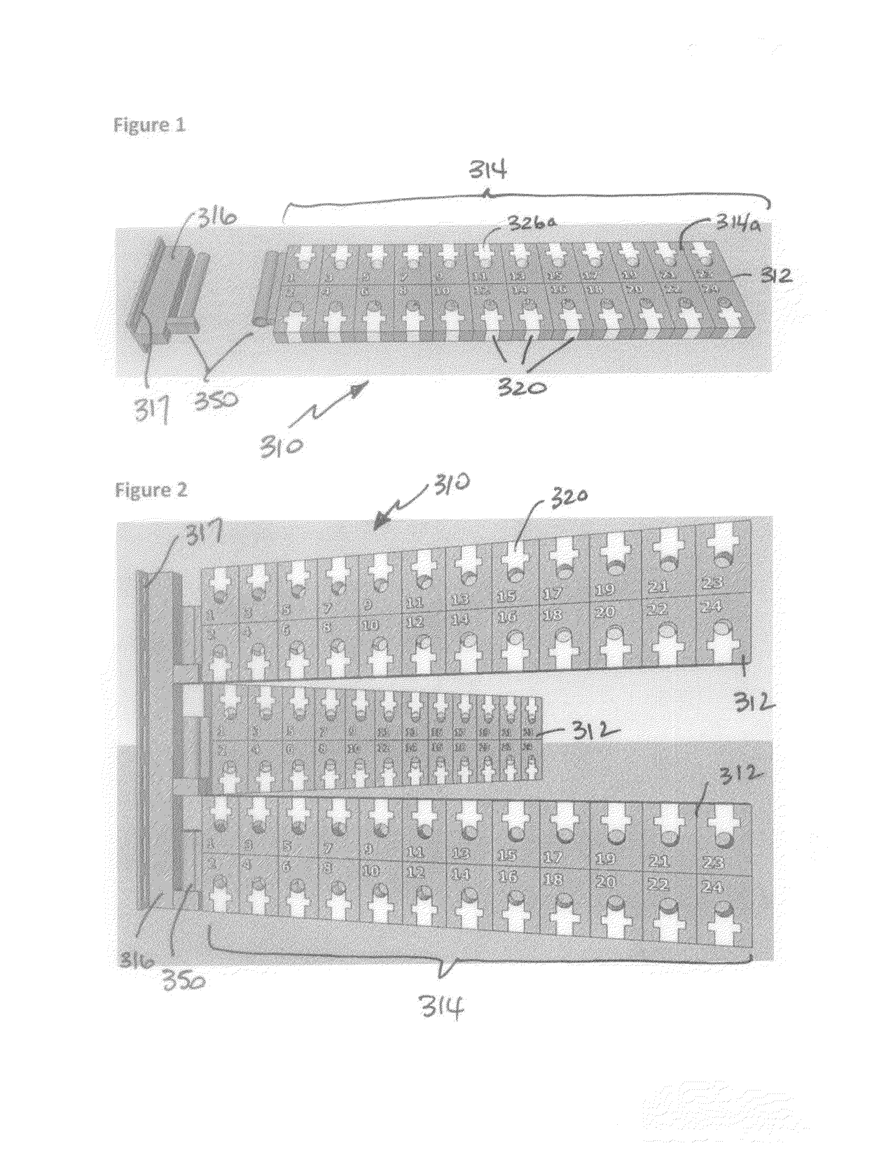

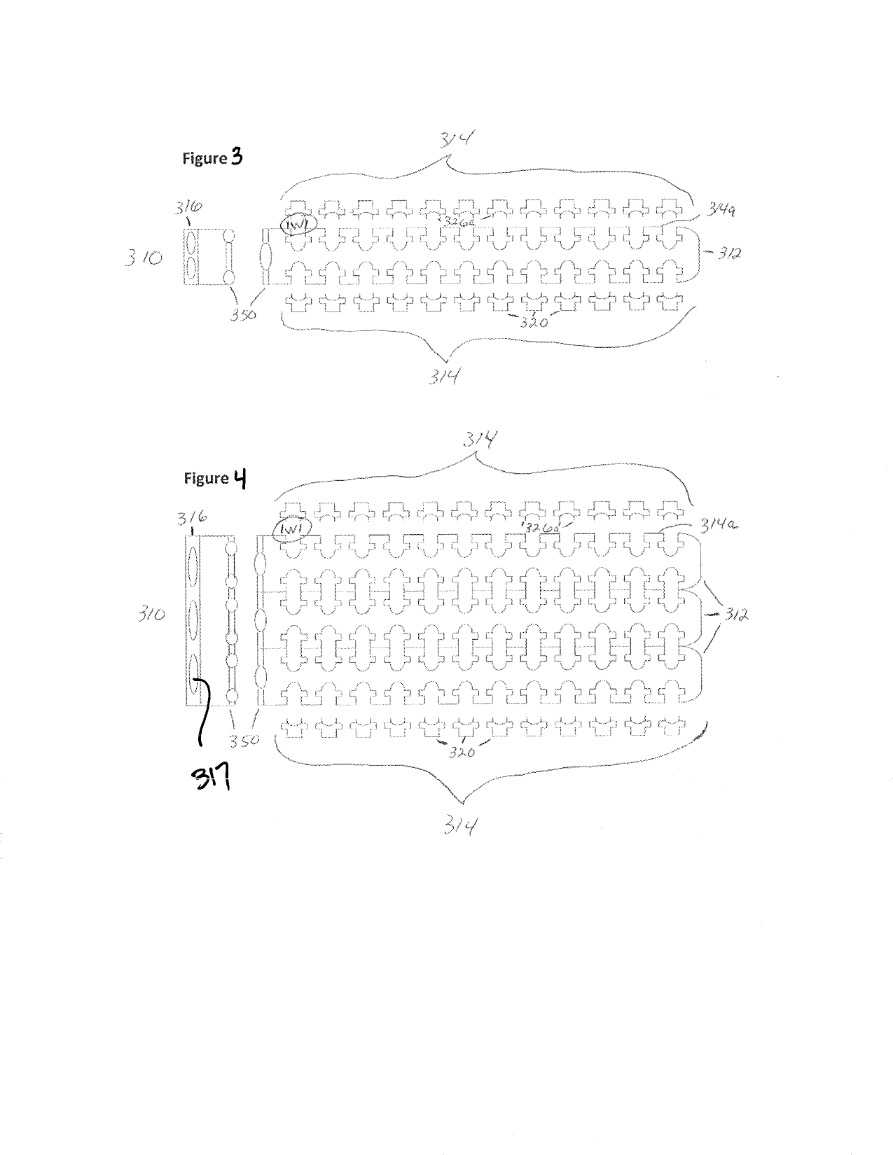

FIGS. 1 and 3 illustrate the embodiment of the present disclosure shown. This embodiment of a cable management device 310 also provides for management of a plurality of cables in a multi-cable environment. Cable management device 310 includes a mount 316 pivotally coupled to a plurality of stationary channel portions 314 by hinge 350. The stationary channel portions 314, as shown, are semi-cylindrical, having a cross-sectional width W that is adapted and constructed to accommodate standard data cables. As shown in FIG. 3, the stationary channel portions 314 have a width of approximately ¼ inch, although it is contemplated that the stationary channel portions 314 could be provided with a width in a range from 1/16 inch to ½ inch, depending upon the specific application. Stationary channel portions 314 are as disclosed in U.S. Pat. No. 7,952,027; filed Dec 29, 2008, entitled Cable Management System, Brian Greick, which patent is fully incorporated herein by reference.

As shown in the exemplary embodiment, each of the stationary channel portions 314 includes a front bracket 314a and a rear bracket (not shown). The front and rear brackets are arranged coaxially with one another and are approximately ½ inch apart. Cable management device 310 also includes mount 316 to facilitate mounting the cable management device 310 onto a planar surface, such as a rack within a data closet or cabinet enclosure. Stationary channel portions 314 are pivotally coupled to mount 316. Mount 316 is formed to include a series of apertures 317 to permit mount 316 to be secured to a board or other support surface.

A plurality of removable members 320 is provided with at least one channel portion 326, corresponding in general configuration with one of the plurality of stationary channel portion 314. Each removable member also includes a front bracket 326a and a rear bracket (not shown) positioned opposite from the bracket 326a. To secure an individual cable, a removable member 320 is inserted between a front bracket 314a and a rear bracket of the stationary member 312. Each removable member 320 is fabricated from a resilient material, allowing for a secure, yet removable interference fit between the front and rear brackets of removable member 320 and the front and rear brackets of stationary member 314.

FIG. 2 illustrates all the above information. In addition to the above information FIG. 2 displays multiple cable management devices stacked on top of each other to act as one device but is not limited to three devices stacked on top of each other. In this embodiment, several stationary channel portions 314 are pivotally connected to mount 316 by use of independent hinges 350. The hinges are designed so that stationary channel potions 314 can be independently removed from mount 316 if desired. Each stationary channel portion 314 can be pivot about hinge 350 independently of the other stationary channel portions 314.

The embodiments disclosed, described and shown herein are for purposes of illustration only, and are not to be construed as constituting any limitations of the invention. Modifications will be obvious to those skilled in the art, and all modifications that do not depart from the spirit of the claims invention are intended to be included within the scope of the appended claims. Those skilled in the art will appreciate that the conception upon which this disclosure is based, may readily be utilized as a basis for the designing of other structures, methods and systems for carrying out the several purposes of the present claimed invention. It is important, therefore, that the claims be regarded as including such equivalent constructions insofar as they do not depart from the spirit and scope of the present invention.

With respect to the above description then, it is to be realized that the optimum dimensional relationships for the parts of the invention, including variations in size, materials, shape, for, function, and manner of operation, assembly and use, and all equivalent relationships to those illustrated in the drawings and described in the specification, that would be deemed readily apparent and obvious to one skilled in the art, are intended to be encompassed by the present disclosure.

Therefore, the foregoing is considered as illustrative only of the principles of the claimed invention. Further, since numerous modifications and changes will readily occur to those skilled in the art, it is not desired to limit the claimed invention to the exact construction and operation shown and described, and accordingly, all suitable modifications and equivalents may be resorted to, falling within the scope of the claimed invention.

What is claimed is:

1. A cable management device for managing a plurality of cables in a multi-cable environment, the device comprising the following:
a stationary member having a plurality of stationary channel portions;
a mounting member pivotally coupled to the stationary member, the stationary member configured to be removable from the mounting member;
an upper movable member and a lower movable member, each movably secured to the stationary member, the upper and lower movable members each having a plurality of movable channel portions corresponding in number and general configuration to the plurality of stationary channel portions;
a plurality of indicia-bearing areas located on the upper and lower movable members corresponding in number, and adjacent to the plurality of movable channel portions;
whereby the upper and lower movable members are movable between a cable placement position in which cables can be placed in the respective stationary channel portions, and a cable retaining position in which the cables are secured in channels formed by the cooperation of the stationary channel portions and the movable channel portions.

2. A cable management device in accordance with claim 1, wherein the stationary member comprises a central stationary member secured between the upper movable member and the lower movable member.

3. A cable management device in accordance with claim 1, wherein the upper and lower movable members are pivotably secured to the stationary member.

4. A cable management device in accordance with claim 3, wherein the upper and lower movable members are each pivotably secured to the stationary member via a pivot pin.

5. A cable management device in accordance with claim 1, further comprising a locking mechanism adapted and constructed to maintain one of the upper movable member and the lower movable member in its cable retaining position.

6. A cable management device for managing a plurality of cables in a multi-cable environment, the device comprising:
a first stationary member having a plurality of stationary channel portions;
a mounting member pivotally coupled to the stationary member, the stationary member configured to be removable from the mounting member;
at least one removable member removably secured to the stationary member, the at least one removable member having at least one removable channel portion corresponding in general configuration to one of the plurality of stationary channel portions;
an indicia-bearing area located on the at least one removable member adjacent to the at least one removable channel portion;
whereby the at least one removable member is configured to engage the stationary member such that a cable can be secured in a channel formed by the cooperation of one of the plurality of stationary channel portions and the at least one removable channel portion.

7. The cable management device of claim 6, further including a second stationary member having a series of removable members removably secured to the second stationary member, the second stationary member is pivotally coupled to the mounting member wherein the second stationary member can be pivoted independently of the first stationary member.

8. The cable management device of claim 7, wherein the first and second stationary members can be selectively removable from the mounting member.
